(19) United States
(12) Patent Application Publication
(10) Pub. No.: US 2013/0014831 A1
(43) Pub. Date: Jan. 17, 2013

(54) Pump coupler

(71) Applicants: Steven Rhea, St. Peters, MO (US); L. Herbert King, JR., Jupiter, FL (US); James Keeven, O'Fallon, MO (US)

(72) Inventors: Steven Rhea, St. Peters, MO (US); L. Herbert King, JR., Jupiter, FL (US); James Keeven, O'Fallon, MO (US)

(21) Appl. No.: 13/385,519

(22) Filed: Feb. 23, 2012

Related U.S. Application Data
(63) Continuation-in-part of application No. 13/135,741, filed on Jul. 14, 2011.

(51) Int. Cl. F04F 10/00; B23P 6/00; F16L 19/00; F04B 53/00

(52) U.S. Cl. 137/149; 137/151; 137/152; 29/888.021; 285/355

(57) ABSTRACT

A suction pump coupler for replacement of the immersible one-way valve with the pump coupler securable to the inlet end of a suction pump for forming a leakproof connection to an intake pipe to enable use of the suction pump in a location wherein the suction pump is remote from the fluid being pumped with the pump coupler operable for securing an inlet pipe to the suction pump in a leakproof condition through rotational engagement of pump coupler with respect to the inlet pipe even with the presence of the suction pump cantileverly mounted thereon.

### CROSS REFERENCE TO RELATED APPLICATIONS

This application is continuation in part of application Ser. No. 13/135,741 filed Jul. 14, 2011.

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

The concept of inexpensive suction pumps for pumping or siphoning a liquid from one location to another is known in the art. One such suction pump, which is shown in U.S. Pat. No. 7,726,231, contains a static immersible one-way inlet valve located on an inlet end of a pump cylinder and a plunger having a dynamic one-way valve located in a lumen within the pump cylinder. The dynamic one-way valve can be axially stroked within the lumen through a handle extending through a top end of the pump cylinder to draw liquid into and through the pump cylinder. Typically, most or all of the components of the suction pump are made from polymer plastics which provides an inexpensive pump as well as a pump that resists oxidation.

The suction pump includes an upper outlet, which is located on the top end of the pump cylinder or pump barrel with the upper outlet connectable to a flexible hose or the like. As the dynamic one-way valve is stroked back and forth within the pump cylinder it draws liquid into and through the pump cylinder. That is, during an upstroke of the dynamic one-way valve liquid is directed into and through the cylinder and the upper outlet and when the dynamic one-way valve is stroked in the opposite direction the dynamic one-way valve opens to allow liquid to pass therethrough while an immersible one-way valve located at the inlet end of the pump remains in a closed condition to prevent liquid from back flowing out of the pump cylinder. If the end of the hose, which is attached to upper outlet of the pump cylinder, is located below a liquid air interface (i.e. the liquid line) of the liquid where the static one-way valve is immersed in the liquid can be siphoned from one location to another since the two one-way valves of the pump cooperate with the pump chamber to allow flow from pump inlet to pump outlet. On the other end the one-way valve prevents back flow from pump outlet to pump inlet if the siphon action is lost.

One of disadvantages of such suction pumps is that the one-way static inlet valve needs to be immersed in a liquid i.e. below the liquid line before the liquid can be drawn into the utility pump. As the immersible one-way inlet valve is located on the inlet end of the pump and extends radially outward from the pump barrel it limits where the pump may be used. While the external size disadvantage of the immersible one-way valve does not affect the use of the pump for removing liquids such as water from open sources of water it makes it more difficult to remove liquids where the size of the access port to the liquid is limited.

One of the features of the suction pump, which is enjoyed by a user, is the use of a large diameter pump cylinder, typically, a diameter of 2 inches or more which enables the user to quickly draw liquid through the pump and start either a siphon process or a pumping process without excessive stroking. For example, with such a large diameter pump barrel one can remove a gallon of water with four strokes of the pump, which makes it desirable for field use. If the utility suction pump is to be used to remove liquids from a source of water or the like that has only a small access port the user needs to use a suction pump with a smaller diameter. However, a smaller diameter pump has a lesser stroke volume or stroke capacity and requires additional strokes to push the same amount of liquid through the pump.

Thus, a pump which has high stroke efficiency or capacity and a large one-way inlet valve may not be suitable for extracting liquid from sources where the inlet access port to the source is smaller than the one-way valve on the end of the pump. Since the immersible one-way valve is threadingly mounted on the exterior surface of the pump it precludes the use of conventional pipe reducers since the reducers would interfere with the operation and placement of the immersible one-way inlet valve.

The invention described herein accommodates multiple uses for a suction pump of high stroke efficiency, without adversely impacting the high stroke capacity of the pump.

### SUMMARY OF THE INVENTION

A suction pump coupler for replacement of the immersible one-way valve with the pump coupler securable to the inlet end of a suction pump in a leakproof sealing configuration wherein the suction pump coupler includes a pump engaging end and an inlet end with the pump engaging end including a sealing member for forming a leakproof seal between the suction pump and a shoulder in the pump coupler to enable use of the suction pump in a location wherein the suction pump is remote from the fluid being pumped with the pump coupler operable for field securing of an inlet pipe to the suction pump in a leakproof condition through rotational engagement of pump coupler having the suction pump cantileverly mounted thereon.

### BRIEF DESCRIPTION OF THE DRAWINGS

FIG. 1 shows a prior art suction pump in partial cross section;

FIG. 1A shows an end view of a prior art immersible one-way valve;

FIG. 2 is an exploded side view of the immersible one-way valve and the adaptor

FIG. 3 is a front view of the adaptor mounted on the end of a pump;

FIG. 4 is a sectional view of the adaptor;

FIG. 5 is a sectional view of the adaptor mounted on the end of a suction pump taken along lines 5-5 of FIG. 4;

FIG. 6 shows a top view of the adaptor;

FIG. 7 shows a cross sectional view of a pump coupler;

FIG. 8 shows a perspective view of a valve support and seal;

FIG. 9 shows the suction hand pump removing water from an underground tank; and

FIG. 10 shows the hand pump with a flexible intake hose.

### DESCRIPTION OF THE EMBODIMENTS

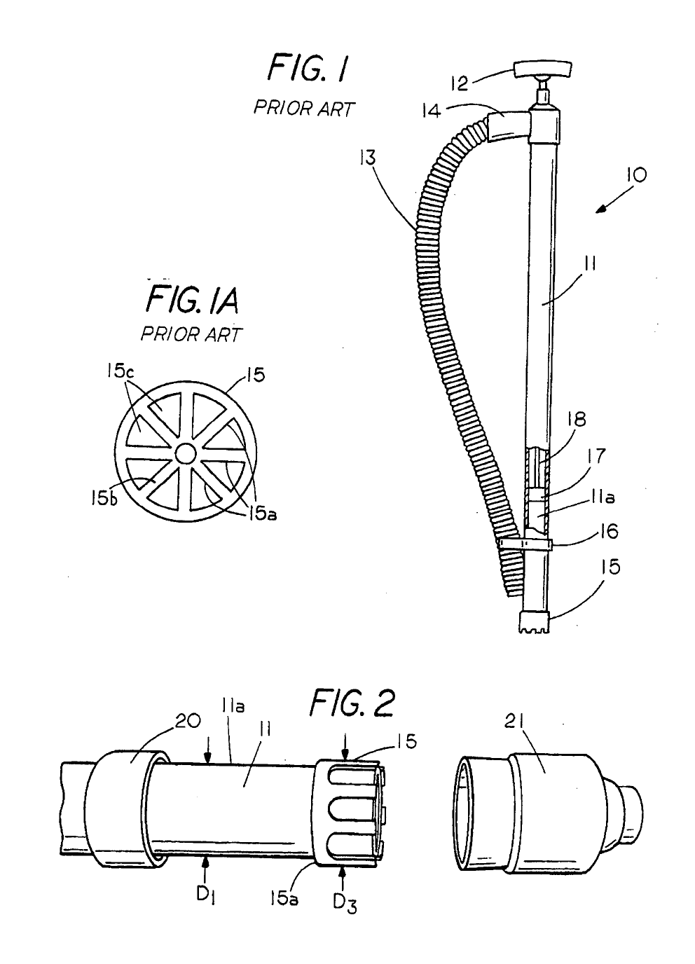

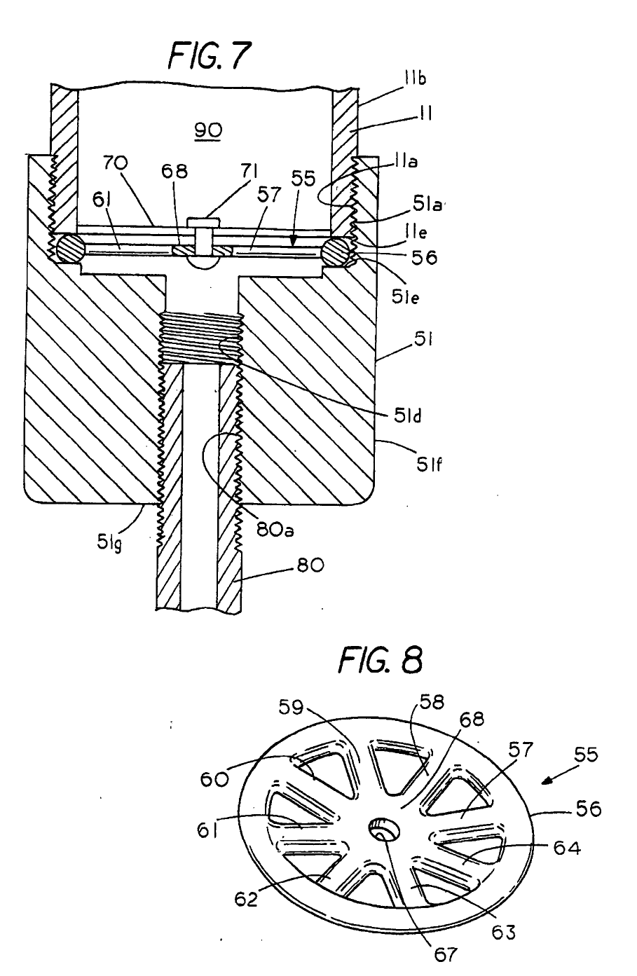

FIG. 1 to FIG. 6 show a suction pump 10 and a pump adapter 21 for attaching over the end of a one-way immersible valve 15 on the suction pump to reduce the profile of the intake to the suction pump and FIG. 7 to FIG. 10 show a pump coupler 51 for replacing the immersible one-way valve 15 on the end of the suction pump to enhance the ability of the suction pump to connect to an external pipe as well as enhance the suction pumps ability to lift fluids without loss of suction pressure and if needed reduce the profile of the intake to the suction pump.

FIG. 1 shows a partial cross sectional view of a prior art suction pump 10 comprising an elongated pump cylinder or pump barrel 11, an immersible one-way inlet valve 15 and a pump outlet tube 14 which connects to one end of a flexible drain hose 13. For convenience in transporting the utility pump the free end of the flexible hose is held proximate barrel 11 by a friction clip 16. A handle 12, which is axially displaceable with respect to cylinder 11, connects to a pump rod 18, which includes a piston or plunger 17 containing a dynamic one-way valve. That is, as the plunger 17 is pushed toward the end of the cylinder containing the immersible one-way inlet valve 15 the dynamic one-way valve in the plunger opens to allow liquid in the pump cylinder 11 to flow upward through the plunger. As the plunger is pulled away from the immersible one-way inlet valve 15 the dynamic one-way valve in plunger 17 closes and the liquid is drawn through the immersible one-way inlet valve 15 and into the pump cylinder or pump barrel 11 of pump 10. Thus, the cooperation of the immersible one-way valve 15 located at the inlet end of the pump barrel 11 and the dynamic one-way valve located on plunger 17 allow one to draw liquid through the immersible one-way valve 15 and discharge it from the open end of flexible hose 13 either through stroking the pump or through a siphon action or both.

FIG. 1A shows an end view of the prior art immersible one-way valve 15 revealing a rigid skeleton frame 15b having a set of pie shaped ports 15a for liquid to enter the pump barrel supporting the one-way valve 15. Located on the downstream side of frame 15b is a resilient disk member or flap 15c which flexes to open ports 15a and allow liquid to flow through ports 15a and into the pump barrel when a suction force is generated on the downstream side of valve 15 by stroking the plunger 17. Flap 15c remains in a closed condition when there is no suction pressure downstream of the flap thus preventing liquid from back flowing out of the pump through the one-way valve 15.

FIG. 2 shows an exploded view of the end of the pump barrel or pump cylinder 11 of pump 10 with the immersible one-way inlet valve 15 secured to the exterior end surface of the pump barrel 11 through pipe threads, adhesives or other means (not shown). The one-piece pump adaptor 21 is positioned in axial alignment with the immersible one-way inlet valve 15 to enable an operator to axially slide adaptor 21 over the one-way static inlet valve 15 until a constricting band 25 of the adaptor 21 is suctionally sealed to a portion of the outer cylindrical surface 11a of pump barrel 11 located downstream of the one-way inlet valve 15. Suctionally sealed is understood to mean that the surface to surface engagement of an interior surface of the adaptor 21 to the exterior surface 11a of the pump barrel 11 is such that it prevents fluid leakage therepast or any fluid leakage therepast is insufficient to defeat the suction forces generated by the pump plunger 17 since defeat of the suction forces would prevent liquids from being siphoned or pumped through the pump.

In the example shown a friction collar 20 is also located on pump barrel 11. Friction collar 20 may be used in the event one wishes to apply additional compression force to more securely maintain the adaptor 21 in a suction seal on the pump barrel 11. The friction collar 20 is shown in cross section in FIG. 5 and includes an internal frusto conical surface 20a which mates with an external frusto conical surface 21c on pump adaptor 21 so that downward axial displacement of friction collar 20 on pump barrel 11 radially constricts the constricting band 25 of pump adaptor 21. However, for most applications the use of a friction collar is unnecessary since a resilient adaptor made from an elastomer can generate a constriction force to suctional seal the band 25 to the exterior surface 11a of pump barrel 11. For example, sufficient sealing forces can be generated by having the internal diameter D₄ of the constricting band 25 less than the external diameter D₁ of the pump barrel. For example, a pump adaptor 21 made from an elastomer such as rubber, is normally sufficient radially contractible to suctionally seal the adaptor 21 to the exterior surface of the pump barrel. On the other hand in some cases one may want to use only a collar to form a fluid tight seal to the pump barrel. In such cases various types of compression collars may be used.

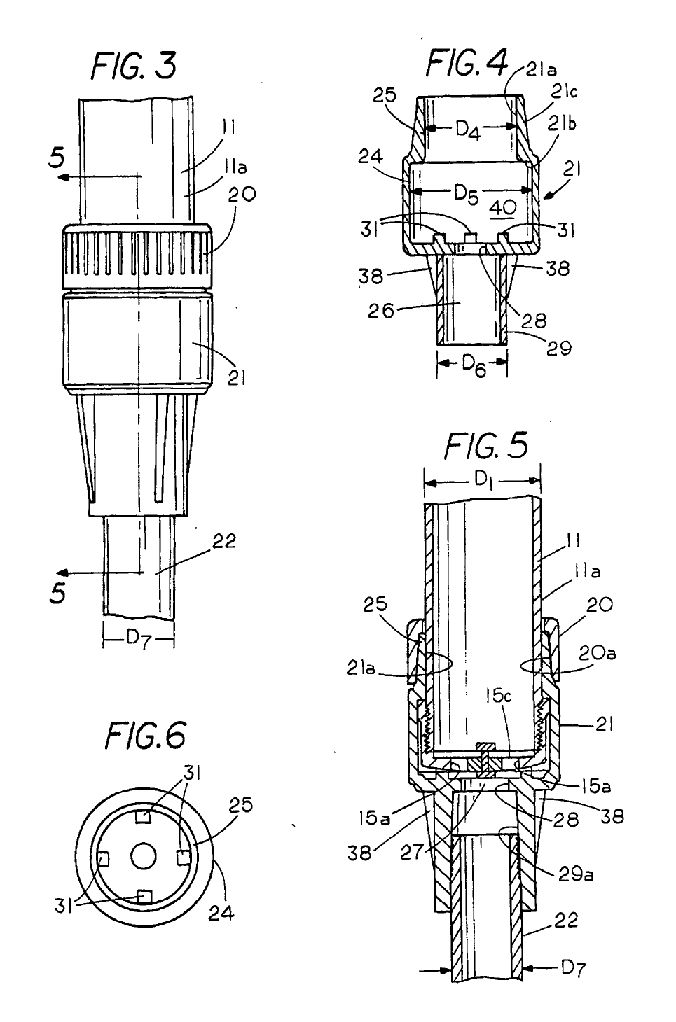

FIG. 3 shows a front view of a lower end of the pump barrel 11 with one end of the adaptor 21 resiliently secured to a portion of the exterior cylindrical surface 11a of pump barrel 11, which is located downstream of the immersible one-way valve, and the opposite end to an inlet pipe 22 having an external diameter D₇, which is smaller in diameter than the immersible one-way valve located on the end of the pump barrel 11. The use of an inlet pipe which is smaller than the immersible one-way valve 15 enables the pump 10 to used in areas where the access port to liquid to be removed is less than the size of the immersible one-way inlet valve or where the liquid to be removed is in a location that is remote or inaccessible to the pump operator. With use of adaptor 21 the end of the pump 10 and the one-way inlet valve thereon need not be located below the liquid line i.e. the interface between air and the liquid. In addition to the resilient securement of the adaptor to the pump barrel 11a a compression collar 20 may be used to further secure the adaptor 21 to the pump barrel 11 through application of a radial constricting force on the outer exterior surface 21c of the pump adaptor 21.

FIG. 4 shows a cross sectional isolated view of the one-piece resilient pump adaptor 21 for reducing the size of a suction pump access inlet to a size less than the external dimensions of the immersible one-way valve, located on the inlet end of the pump. The reduction occurs without decreasing pump stroke capacity, without disrupting the external configuration of the utility pump and allows one to use the pump in conditions where the one-way valve 15 is located above the liquid line of the liquid being suctioned.

The pump adaptor 21 is preferably made from a resilient elastomer and can be radially expanded to allow the pump adaptor to be axially slipped over the one-way valve 15 by user hand pressure. FIG. 5 shows the pump adaptor 21 frictionally and mechanically mounted on the end of pump barrel 11 proximate the immersible one-way valve 15. The upper portion of pump adaptor 21 includes a radially elastically stretchable suction pump constricting band 25 having an annular sealing surface 21a of diameter D₄ for forming a radially constricting suction seal against the larger diameter exterior cylindrical surface 11a of pump barrel 11 through the resiliency of the material of adaptor 21. By having the inside diameter D₄ of the constricting band 25 less than the outside diameter D₁ of the pump barrel 11 the resiliency of the constricting band 25 exerts a radial inward pressure to maintain a suction seal between the exterior cylindrical surface of pump barrel 11 and the interior annular sealing surface 21a of adaptor 21.

FIG. 4 shows an encapsulation band 24 having a chamber 40 with the chamber therein preferably having a diameter D₅ which larger than both the internal diameter of the pump constricting band 25 and the diameter D₃ of the static one-way valve 15 as well as a length greater than the length of the one-way valve 15. The purpose of the encapsulation band 24 is to allow one to encapsulate and fluidly isolate the one-way valve 15 so that the adaptor 21 will not adversely affect the performance of the one-way valve 15. While the encapsulation band could be made to constrict to the exterior surface of pump adaptor it is preferred that for ease of application and because of the lack of peripheral sealing surfaces on the one-way valve 15 that the encapsulation band have a diameter equal to or greater than the diameter D₃ of the one-way valve 15. The encapsulation band 24 is configured so as to not interfere with the operation of the one-way valve 15 by providing a fluid chamber 27 (FIG. 5) proximate the inlet end of the one-way valve 15 so the inlet region of one-way valve 15 can remain in contact with a liquid i.e. an equivalent of an immersed condition when liquid is being drawn through pump 10.

FIG. 4 shows an annular lip 21b that functions to smoothly connect the constricting band 25 with the encapsulation band 24, however, it can also function as an axial stop to prevent adaptor 25 from being accidentally pulled free from pump barrel 11 since lip 21b can mechanically engage a top edge 15a (FIG. 2) of one-way valve 15 if an axial withdrawal force is applied to adaptor 25.

FIG. 4 illustrates that adaptor 25 includes a further axial stop comprising a set of axial protrusions 31 for engaging the non-operative parts of the one valve 15 and an inlet passage 28 which provides continuous fluid access to a chamber 27 proximate the inlet end of the one-way valve 15. The chamber 27 allows liquid to be drawn into and through the one-way valve 15 without interfering with the conventional operation of the immersible one-way valve 15 by providing for liquid in the region proximate the ports 15a of the one-way valve 15. The lower axial stop 31, which is shown as set of axial protrusions prevents the adaptor 21 from sliding upwards which would block the ports 15a of one-way valve 15. Thus, a feature of the invention is that the pump adaptor 15 can be mounted on a pump barrel with the pump adaptor maintained in a static axial position on the pump barrel 11 through a constriction band 25 of the adaptor 21 engaging the pump barrel. Alternatively where axial forces may disrupt a friction engagement between the adaptor on the pump barrel the constriction band 25 together with the coaction of the annular axial stop 21b and the lower axial stop 31 may be used to prevent axial displacement of the pump adaptor with respect to the pump cylinder.

FIG. 4 and FIG. 5 shows that an inlet band 29 is integral to encapsulation band 21 with inlet band 29 having an external diameter D₆ which is less than the internal diameter of the suction pump constricting band 25, the pump barrel 11 and the diameter of the one-way valve 15. That is, when the inlet band 29 is used for immersion into a liquid, which is to be suctionally extracted, the inlet band provides for a smaller profile to allow the suction pump to be used in places where the liquid access ports are too small to accommodate the immersible one-way valve 15 on the end of pump 10. To accommodate even smaller access ports a suction pipe 22 of diameter D₇ can be suctionally sealed to inlet band 29. If a suction pipe 22 is attached to the inlet band 29 of the pump adaptor 15 the external diameter D₆ of the inlet band 29 need not have a reduced diameter as shown in FIG. 5 since the external diameter D₇ of the suction pipe 22 will determine the size of ports that can be accessed 4. Thus, the one-piece cylindrical suction pump adaptor 21 may include an elongated suction tube 22 suctionally sealed to the inlet band 29 with the elongated suction tube 22 having an outside diameter less than the internal diameter D5 of the encapsulation band 24.

A feature of the use of a separate suction pipe 22 for attachment to the pump adaptor 21 is that the external diameter of the inlet band 29 need not be smaller than the inside diameter of the encapsulation band 24 since suction tubes of different and lesser external diameters may be interchangeable connected to the inlet band 29 of adaptor 21 through conventional pipe fittings or the like thus allowing the operator not only the choice of the size of the external diameter of the suction tube but to make on-the-go changes of the size of suction tube while at a job site.

If desired, in some cases, the portion of the one-piece cylindrical suction pump adaptor wherein the elongated tube is suctionally sealable through resilient engagement therewith may includes a set of external buttresses 38 for stiffing or preventing suction collapse of the inlet band during suction of liquids therethrough.

As can be seen in FIG. 4 and FIG. 5 pump adaptor 21 may consist of a one-piece resilient member with axially spaced multiple bands with each of the bands cooperating to quickly allow one to slip the pump adaptor 21 over an immersible one-way valve 15 located on the end of a pump 10 to reduce the size of the suction inlet to the pump 15 without affecting the stroke capacity of the pump. In addition, the adaptor 21 allows the existing one-way valves in the pump 10 to function in therein normal manner while at the same time providing a suction pump that can be used to draw liquids from areas where the access port is normally to small for access by the immersible one-way valve located at the inlet end of pump 10.

Thus the suction pump as shown in FIG. 1 and FIG. 5 includes a pump cylinder 11 having a lower inlet 15 and an upper outlet 14 and a lumen 11b therein. Located in lumen 11b is an axially slideable plunger 17 having a one-way valve thereon for drawing liquid from the inlet to the outlet of the cylinder.

As shown in the drawings the liquid immersible one-way valve 15 is located on an inlet end of the pump cylinder 11 to enable a liquid to be suctioned through the liquid immersible one-way valve 15 by axially stroking the plunger 17 within the cylinder 11. Attached to the lower end of the pump cylinder 11 is a three part resilient adaptor 21 with the resilient adaptor 21 having a constricting band 25 sealingly engaging an exterior cylindrical surface 11a of cylinder 11, an encapsulation band 24 for encapsulating the liquid immersible one-way valve 15, an inlet extension 29 having an outside diameter preferably smaller than an outside diameter of the liquid immersible one-way valve 15 and a suction chamber 27 for suctioning of fluid through an extension 22 and into proximity of the liquid immersible one-way valve 15. If desired one can lock the pump adaptor 21 in position through an annular stop 21b that mechanically prevents the pump adaptor from sliding off the pump barrel 11 and a stop 31 that mechanically prevents the pump adaptor 15 from sliding to far over the one-way valve and thus interfering with the operation of the one-way valve 15.

A further feature of the invention includes a field method of reducing the inlet size of a suction pump having an immersible one-way valve without the aid of tools by on-the-go placing a sealing surface 21a of a pump adaptor 21 into a suction sealing engagement with an exterior surface 11a of a pump barrel 11 by radially expanding a constricting band 25 on the adaptor to slide the sealing surface 21a past the one-way valve 15 and into a position proximate an exterior surface 21a of a pump barrel. Allowing the resilient constricting band 25 to radially contract brings the constricting band into a suctional seal with the external surface of pump barrel. One can then place an encapsulation band 24 of the pump adaptor circumferentially around the non-immersible one-way valve 15 with a rigid frame 15b of one-way valve 15 in engagement with axial stop 31 to form a suction chamber proximate the one-way valve 15. An extension 22 on the adaptor can then be used for suction of liquids therethrough. The extension may include a tube that can be frictional secured thereto in a suction seal to prevent air leakage therepast during the operation of the utility pump.

FIG. 7 shows a cross sectional view of a suction pump coupler 51 comprising a rigid cylindrical coupler 51 having a first female thread 51a on one end and a second female thread 51d on the opposite end. In the example shown the first thread 51a is in threaded engagement with a thread 11a on the exterior surface 11b at the end of pump barrel 11. The second female thread 51d, which is located on the second or intake end of the coupler is in threaded engaging with an intake pipe 80. In the example shown the thread 51d is a female pipe thread and the thread 80a is a male pipe thread which due to their inherent taper can be rotated into a sealed or leakproof condition therebetween.

Located in an intermediate position between the ends of coupler 51 is an annular shoulder 51e, which is shown in engagement with an upstream side of annular rim 56 of a support wheel 55. Support wheel 55, which is shown in isolated view in FIG. 8, comprises an annular outer rim 56 having a cylindrical cross section and a set of spokes 57-64 extending radially inward to a hub 68, which includes a central opening 67. In the example shown the lower cylindrical end 11e of the pump barrel 11 is in engagement with a downstream side of rim 56 and the shoulder 51e is in engagement with the upstream side of rim 56 which allows the spokes 57-64 to tensionally support any weight of the fluid above disk 70 as one strokes the pump.

In order to pump out fluids from remote locations the conventional immersible inlet valve 15, which is shown in FIG. 1 and FIG. 5, has been removed and replaced by an internal support wheel 55 with the support wheel having a sufficiently resilient rim 56 that can be compressed into a leakproof seal between the cylindrical end 11e of tube 11 and the annular shoulder 51e of the pump coupler 51. An example of a suitable material that can provide both support and sealing capacity is nitrile rubber having a hardness of least 80-90 on the ASTM D2240 A scale.

In this example the annular rim 56 functions as a second seal while the interior portion of spokes 57-64 and hub 68 functions as a lower support for one-way valve 70. That is, the rotation of coupler 51 with respect to pump barrel 11 compresses rim 56 between shoulder 51e and cylindrical surface 11e to provide a second leakproof seal between the pump barrel 11 and the pipe coupler shoulder 51e. Thus, the combination of the first sealing pipe threads 11a and 51a and the second sealing rim 56 located between surface 11e and 51e enable one to form two seals in series to thereby reduce the opportunity for fluid leaks that would cause loss of suction during a pumping cycle.

Consequently, in one example of the invention shown herein allows field personal to on-the-go form two leakproof seals in series between the polymer plastic pump barrel 11 and the rigid coupler 51. The rigid coupler may be metal or the like 51, for example steel, to ensure that the pump coupler can be tightened sufficiently against a metal pipe through an external pipe thread on the pipe. One needs to ensure that there are no leaks so that the pump 10 can be used to draw liquids therethrough without loosening the suction capacity. In most cases a single seal is sufficient but in some applications, such as when the suction pump is drawing fluid from depths which are close to the limits of the suction pump small leaks can destroy the suction causing the pump to fail thus preventing the suction pump from achieving its inherent suction capacity. In such cases one may want to consider the use of the seals in series which enhances the ability of the pump to draw liquid therethrough without developing leaks even though the pump may be made from inexpensive materials.

Thus the pump coupler 51 includes a first end having a first female pipe thread 51a for engaging a surface 11b of a suction pump 95, a second end having a second female thread 51d for engaging a male thread 80a on intake pipe 80 and a flat annular sealing shoulder 51e located internal to pump coupler 51. A support wheel 55 having a sealing rim 56 having a cylindrical cross section enables one to form sealing engagement between the shoulder 51e and an end 11e of the suction pump barrel 11 to prevent leakage of outside air into the pump during stroking of the pump 95.

The flexible disk 70, which functions as a one-way valve, is centrally secured to the hub 68 by a rivet or fastener 71. Disk 70 is supported on the underside by the spokes of support wheel 55, which enables the disk 41 to function as a one-way valve to prevent backflow through the suction pump. That is, the disk 41 provides a one-way inlet valve at the inlet to pump barrel 11. The support wheel 55, which contains a set of spokes 57-64 with openings therebetween for fluid to flow through, is used to support the underside of the flexible disk 70, which is secured to the hub 68 through a rivet or fastener 71. A feature of the support wheel 55 is that the material is sufficiently resilient so that in the rim region 56 the support wheel 55 can be compressed to form a leakproof seal. In the central region the spokes 57-64 support the lower side of one-way valve 70. In the example downward force on disk 70 is resisted by tensional forces in the spokes 57-64 since the rim 56 is clamped between the end 11e of the pump barrel and the shoulder 51e of the pump coupler 51. Examples of materials that may be used for the support wheel 55 include rubber although other materials which provide for sealing and provide tensional resistance may be used. Thus, a feature of the invention is that one may clamp the rim 56 of the one-piece support wheel 55 between the end of the pump barrel 11 and the shoulder 51 to place the spokes 57-64 in tension when a column of fluid is located on top of the one-way valve 70 to thereby hold the one-way valve in a sealed condition during a down stroke of the pump 95.

FIG. 7 shows flexible disk 70 in the sealing condition to prevent backflow of fluid therepast. When fluid is drawn into lumen 90 barrel 11 through an upward stroke on pump 95 the peripheral edges of disk valve 70 flex upward to allow the fluid to enter the lumen 90 in barrel 11. As the plunger 17 enters the down stroke the resilient disk valve 70 returns to the sealing condition illustrated in FIG. 7 thereby preventing backflow through the pump as long as there are no leaks that would cause the suction to be lost.

In the example shown in FIG. 7 the external immersible intake valve 15 has been replaced by pipe coupler 51 that contains an annular shoulder 51e for forming an annular sealing seat for supporting an annular sealing member 56 between the end of the pump barrel 11 and the coupler to thereby provide a leakproof seal between the coupler 51 and the pump barrel 11, which allows the pump to be used to draw fluid from remote elevations that are well below the elevation of the suction pump since the intake valve need not be immersed in a fluid to draw fluid through the suction pump. In addition the use of the internal seal between the coupler 51 and the pump barrel 11 provides an internal leakproof seal that allows the suction pump to draw fluid from normally inaccessible locations or elevations not attainable with the immersible suction valve 15 shown in FIG. 1. At the same time the placement of the spokes 57-64 in tension aids in supporting the one-way disk valve 70 to ensure that one can draw fluid from the maximum permissible elevations of a suction pump sine the one-way disk valve 70 can prevent backflow.

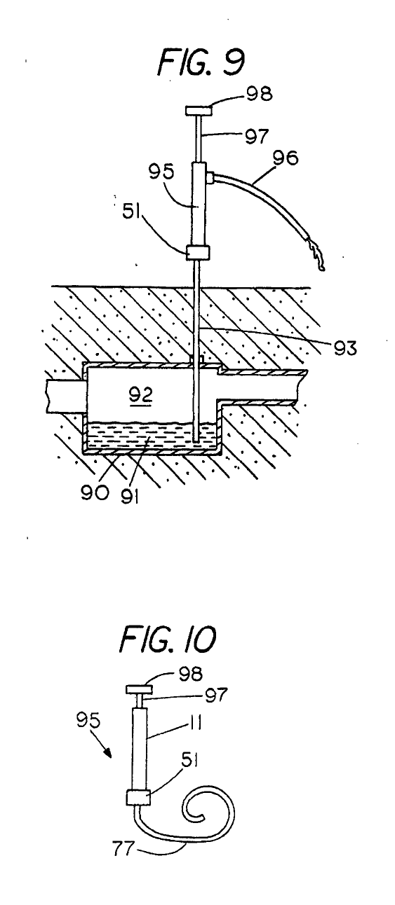

FIG. 9 shows an example of a suction pump 95, which is used to remove fluid such as water from an underground tank 90. In this example the tank 90 contains water 91 and a pipe 93, which has the lower end extending below the water line and into the water. The suction pump 95 having the coupler 51 is secured to pipe 93 through a pipe coupler 51. A feature of this example is that by having pipe threads on both the intake pipe 80 and the pipe 93 a pump coupler can be rotated into sealing engagement with pipe 93 at a field work site to provide a leakproof joint though the mechanical interaction between the pipe threads on pipe 93 and the threads 51d on coupler 51. If the pipe coupler 51 is made from a rigid material such as metal and includes a pipe thread and the pipe 93 is also made from a rigid material such as metal and also includes a pipe thread one can quickly form an onsite metal to metal sealing contact between pipe 93 and coupler 51 that enables one to remove the unwanted liquid from the tank 90 though use of the suction pump 95. Once the unwanted liquid is removed one can unscrew the pipe coupler 51 from the pipe 93 and proceed to the next location where fluid needs to be pumped out. 15. Thus the invention includes the method of removing unwanted fluid from an underground tank 90 having an end of a pipe 93 extending therefrom and a further end of the pipe 93 extending into a pool of unwanted fluid 91 in the underground tank. By placing a pump coupler 51 on an end of a suction pump 95 to form a leakproof seal between an inlet end 11e of the suction pump 95 and the pump coupler 51 and then threadingly securing an inlet end 51g of the pump coupler 50 to the end of the pipe 93 to form a leakproof connection between the inlet end of the coupler and the end of the pipe by rotating the pump coupler 51 with respect to the pipe with the use of pipe wrench or the like. One can then stroke the suction pump 95 to remove the unwanted fluid by drawing the unwanted fluid through the pipe and discharging the fluid from an outlet of the suction pump as shown in FIG. 9.

FIG. 9 shows a rigid pipe 93 attached to pump coupler 51 through male pipe threads on pipe 93 and female pipe threads on pipe coupler and FIG. 10 shows another example wherein the pipe coupler 51 connects to a flexible but semi rigid hose 77 that can be bent but still withstand suction forces without collapsing. This feature allows the suction pump 95 to be used in areas where the access port to unwanted fluid is of limited size. Thus the suction pump 95 may be used with any of three different operational modes i.e. with a submersible inlet valve 15, with a pump adaptor 21 or with a pump coupler 81 to enable removal of unwanted fluids under a variety of conditions.

We claim:

1. A pump coupler for a suction pump comprising:
a first end having a first thread for engaging a surface of a suction pump;
a second end having a second thread for engaging an intake pipe;
a shoulder located internal to said pump coupler;
a support wheel having a sealing rim for sealing engagement with the shoulder and a suction pump barrel and the coupler to form a leakproof seal therebetween.

2. The suction pump coupler of claim 1 wherein the support wheel contains a hub and a set of spokes connected to said rim forming a set of radial openings therebetwen.

3. The pump coupler of claim 2 including:
a flexible disk; and
a pin securing a portion of said disk to said hub to form a one-way valve.

4. The pump coupler of claim 1 wherein the pump coupler comprises a rigid material having a cylindrical surface engageable with a pipe wrench for rotationally securing the pipe coupler to the suction pump barrel and to the intake pipe through rotation of the pump coupler.

5. The cylindrical suction pump coupler of claim 1 wherein the support wheel is nitrile rubber having a durometer of at least 80 on the ASTM D2240 A scale.

6. The pump coupler of claim 1 wherein the second thread comprises a pipe thread.

7. The pump coupler of claim 1 wherein the first thread comprises a female pipe thread for engaging a male pipe thread on a suction pump barrel for forming a second seal in series with the seal formed by the end of the suction barrel and the shoulder of the pipe coupler.

8. The pump coupler of claim 1 including a flexible tube secured to the second end of said pump coupler.

9. A suction pump comprising:
a pump barrel having an inlet, an outlet and a lumen therebetween;
a plunger slideable in the lumen with the plunger having a one-way valve thereon for drawing liquid through the pump barrel;
a further one-way valve located on the inlet end of the pump barrel to enable a liquid to be suctioned through the further one-way valve by stroking the plunger within the pump barrel;
a pump coupler having an internal shoulder, said pump coupler secured to the pump barrel through a leakproof joint; and
an inlet end on said pump coupler for connection to a fluid intake pipe.

10. The suction pump of claim 9 wherein the pump coupler is a rigid material and the pump barrel is a polymer plastic with the pump barrel extending in a cantilevered condition from the pump coupler.

11. The suction pump of claim 9 wherein the further one-way valve includes a support wheel having a rim and a hub with a set of spokes connecting said hub to said rim.

12. The suction pump of claim 11 wherein the further one-way valve comprises a disk valve centrally secured to the hub to enable a peripheral portion of the disk valve to flex away from the support wheel to allow fluid therepast during an upstroke of the suction pump.

13. The suction pump of claim 12 wherein the pump coupler includes a female tread for engaging the pump barrel and a female thread for engaging the fluid intake pipe.

14. The suction pump of claim 10 wherein the rigid material comprises steel with an external cylindrical surface engageable with a pipe wrench for rotation of the inlet end of the pipe coupler into sealing engagement with an intake pipe while the suction pump is cantilevered from an opposite end of the pipe coupler.

15. The method of removing unwanted fluid from an underground tank having an end of a pipe extending therefrom and a further end of the pipe extending into a pool of unwanted fluid in the underground tank comprising:
placing a pump coupler on an end of a suction pump to form a leakproof seal between an inlet end of the suction pump and the pump coupler;
threadingly securing an inlet end of the pump coupler to the end of the pipe to form a leakproof connection between the inlet end of the coupler and the end of the pipe by rotating the pump coupler with respect to the pipe; and
stroking the suction pump to remove the unwanted fluid by drawing the unwanted fluid through the pipe and discharging the fluid from an outlet of the suction pump.

16. The method of claim 15 using a pipe wrench to rotate the pump coupler by engaging an external cylindrical surface of the pump coupler with a set of jaws of the pipe wrench.

17. The method of claim 15 wherein the pump coupler and the suction pump are rotated as a unit as the pump coupler is connect to the end of the pipe.

18. The method of claim 15 wherein the inlet end of pump coupler includes a female pipe thread and the end of the pipe includes a male pipe thread.

19. The method of claim 15 including securing the pump coupler to the end of the pipe in a leakproof condition solely through rotating the pump coupler with respect to the end of the pipe.

20. The method of claim 18 wherein the pump coupler is metal and the suction pump is a polymer plastic cantilevered from an end pump coupler so that the rotation of the pump coupler with respect to the further end of the pipe inhibits strain on the suction pump while forming a leakproof seal between a pipe thread on the pump coupler and a pipe thread on the end of a metal pipe.
